(19) United States
(12) Patent Application Publication
(10) Pub. No.: US 2003/0023563 A1
(43) Pub. Date: Jan. 30, 2003

(54) Flexible license payment method for electronic commerce systems

(76) Inventors: Ken Kutaragi, Kanagawa (JP); Akira Saito, Saitama (JP); Tanjo Wakimoto, Chiba (JP); Toru Kuwahara, Yokohama (JP); Kazuya Tamura, Tokyo (JP); Hajime Hirano, Saitama (JP); Masayuki Chatani, Sunnyvale, CA (US); Philip D. Palmer, Mtm View, CA (US); Colin B. Maclean, Belmont, CA (US); Anne Ai-Yu Chen, San Francisco, CA (US)

Correspondence Address: William S. Frommer, Hans R. Mahr, Frommer Lawrence & Haug LLP, 745Fifth Avenue, New York, NY, 10151, US

(21) Appl. No.: 09/936,882

(22) PCT Filed: Jan. 16, 2001
(86) PCT No.: PCT/US01/01427

(30) Foreign Application Priority Data
Jan. 17, 2000 (JP) 2000-08253
Jan. 30, 2000 (JP) 2000-22553
Jun. 9, 2000 (JP) 2000-173754

(51) Int. Cl. G06F 17/60

(52) U.S. Cl. 705/52

(57) ABSTRACT

This invention provides a stocking-burden-reducing sales-management system for articles such as computer readable media upon which an executable computer program is written. In a sales management server 1, an order-delivery processor 120 performs order and delivery processing with a manufacturer terminal 3. An order accepting unit 130 receives order information from a customer terminal 2, stores the order information in a sales database 170, and performs inventory management processes. A charging processor 140 performs the task of charging customers. The charging processor also determines a royalty to be paid to an added value creator of the article, and then transmits the information to an added value creator terminal 4. A delivery instruction unit 150 provides an instruction of delivery of the ordered articles to a delivery terminal 8.

### CROSS REFERENCE TO RELATED APPLICATIONS

This application claims priority based on Japanese Patent Application No. 2000-8253, filed on Jan. 17, 2000; Japanese Patent Application Nos. 2000-22553, and 2000-173754 filed on Jan. 31, 2000, and Jun. 9, 2000, respectively; and U.S. patent application Ser. No. 09/625,692 filed on Jul. 26, 2000, the entire contents of which are incorporated herein by reference for all purposes.

### FIELD OF THE INVENTION

The present invention relates generally to computer networks and electronic commerce, and more specifically to a sales management system incorporating an inventory management process and flexible royalty payment method for distributed software products.

### BACKGROUND OF THE INVENTION

Entertainment systems often include a computer comprising predetermined hardware and executable software that involves many different parties and various cost components, such as manufacturing costs, distribution costs, and license or royalty payments. A company specializing in software development typically enters into a license contract with a company that manufactures and sells the computer. The software-developing company develops a program for the computer, based on disclosure of the specifications of the computer. The developed program has a large added value. In other words, the computer-program developing company creates added value. The computer-program developing company is hereinafter called the “added value creator”. In general, the added value creator who developed the program reserves the copyright of a program, and the right to manufacture and sell the program, along with other such rights.

The added value creator typically orders articles for sale, for example, recording media such as CD-ROM (Compact Disk-Read Only Memory) devices containing the program, from a factory. Articles manufactured by the factory are delivered to the added value creator. The added value creator can sell the delivered articles through the added value creator's own selling channel. An added value creator without his or her own selling channel sells the articles to a wholesaler for sale. Even an added value creator having his or her own selling channel may sell the articles to a wholesaler in some situations. The wholesaler temporarily keeps the articles in stock, and sells the articles in stock to a retailer. The retailer then sells the articles to customers.

Referring to the value of each article, at a stage in which the added value creator receives the articles from the factory, the value of each article is a CD-ROM manufacturing cost (a). At the next stage in which the wholesaler purchases the articles, a consideration (b) to be paid to the added value creator is added, and the value of each article in stock is (a+b). The amount (a+b+d) obtained by adding a wholesaler charge (d) to the value (a+b) is a selling price to the retailer. In the value of each article in stock (a+b), the consideration (b) to the added value is normally several times to several tens of times the CD-ROM manufacturing cost (a).

In general, the largest part of total sales is achieved during the several weeks immediately after the first date of sale after an article, such as recording media (CD-ROMs) containing the computer-executable is released. Thus, when the articles are out of stock during this period, valuable selling opportunities are lost. Accordingly, when a great number of articles are expected to be sold, the added value creator wishes to keep as many articles as possible in stock without losing opportunities to sell the articles.

However, since the wholesaler and the retailer purchase the articles in stock at a price including the consideration to the added value, it is not financially advantageous to increase the number of articles in stock since this can cause a rapid increase of assets. In addition, since unsold articles result in losses, the economic risk of stocking a large number of articles is also large. On the other hand, the added value creator cannot reduce the risk of losing selling opportunities unless the number of articles in stock in the wholesaler and the retailer is increased.

The widespread use of computer networks has encouraged the distribution of software products on-line rather than strictly through the sales and distribution of tangible media-based products, such as CD-ROMs. In this case, when a program is distributed through a network, it is not always known when the consideration accrues corresponding to the added value. This makes cost accounting difficult for this type of distributed product.

One type of consideration that is typically included in a distributed software product is a royalty to be paid to the added value creator. Concerning articles like recording media such as CD-ROMs, to which a computer-executable program is affixed, a significant portion of the selling price of a distributed software product is often the royalty or license fee that is charged to the publisher of a software product by the software developer or author of the program. Typical royalty rates can run from five percent to ten percent of the sales price of a product. In present software distribution systems, the publisher is often required to pay the license fee up front upon the production of a product. This payment represents a significant up-front cost to the publisher. Moreover, the royalty rate is paid to the software author (licensor) even if the products are never sold to a customer. This system thus forces publishers to bear a significant and risky cost component for new software products. For products with a short duration or unknown sales potential, many publishers may be unwilling to pay the license fee up front. This can severely limit the publishing opportunities for software authors, and other added value entities that desire to obtain licensing revenue for their products.

Although for certain software products, such as games or music, the largest part of total sales is often achieved within several weeks from the date the first version is released, requiring a software publisher to maintain high initial stock levels that include the royalty or license fee added value consideration can be burdensome. Furthermore, the economic risk is an additional burden that can be considerable, since the unsold articles result in losses, not just of the manufacturing cost, but also of the added value consideration.

### SUMMARY OF THE INVENTION

In view of the above-described problems, it is an object of the present invention to provide technology for sales management that reduces the stocking burden.

Further, it is another object of the present invention to provide technology for determination of a consideration corresponding to an added value.

It is yet another object of the present invention to provide a software distribution system that provides for flexible payment of license fees for royalty bearing products, such as computer software.

It is a further object of the present invention to provide an electronic-commerce distribution system that assigns license fee payments to distributed software products upon the sale of the products to customers.

Embodiments of the present invention include a system that processes a product order by receiving at least article-identification information and the number of articles whose sales price is determined according to the added value, and based on the article-identification information, a consideration is determined corresponding to the added value, which is to be paid to the creator of the added value.

The order is accepted by receiving at least article-identification information and the number of articles whose sales price is determined according to the added value, and based on the information confirming sales of ordered article, a consideration is determined corresponding to the added value, which is to be paid to the creator of the added value. Examples of the information confirming sales includes a delivery instruction information, shipping information, and sales information.

Embodiments of the present invention also include a flexible license payment method for electronic commerce system is disclosed. For articles each having a selling price determined in accordance with at least an article manufacturing cost and an added value thereof, the electronic commerce distribution system comprises an electronic commerce distribution server computer, one or more added value creators, and a distributor, and can operate in an environment that includes other computers associated with the parties and networked together. The products, each having a selling price determined in relation to a manufacturing cost and an added value, are purchased at the manufacturing cost; the purchase price is then stored, and the articles are held in stock. After the articles in stock are sold, the added value of each product sold is referenced, and a consideration corresponding to the added value is paid to the added value creator Where the added value represents a license fee owed by the distributor to the product author, the license fee is not charged until the product is sold to a customer.

Other features and advantages of the present invention will be apparent from the accompanying drawings and from detailed description that follows.

### BRIEF DESCRIPTION OF THE DRAWINGS

The present invention is illustrated by way of example and not limitation in the figures of the accompanying drawings, in which like references indicate similar elements, and in which:

FIG. 1 is a functional block diagram of a sales management system according to an embodiment of the present invention;

FIGS. 2A and 2B are illustrations of data items of tables stored in a sales database in an embodiment of the present invention;

FIGS. 3A and 3B are illustrations of data items of tables stored in an article database in an embodiment of the present invention;

FIG. 4 is an illustration of data item of a table stored in a member database in an embodiment of the present invention;

FIG. 5 is an illustration of order information for informing a server of an order from a member in an embodiment of the present invention;

FIG. 6 is an illustration of an example of a new-membership recording screen displayed on a member terminal;

FIG. 7 is an illustration of an example of a login screen displayed on a member terminal;

FIG. 8 is an illustration of an example of a main menu screen displayed on a member terminal;

FIG. 9 is an illustration of an example of a delivery-destination-address additional-recording screen displayed on a member terminal;

FIG. 10 is an illustration of an example of an input screen for keyword search, which is displayed on a member terminal;

FIG. 11 is an illustration of an example of a search result indication screen displayed on a member terminal;

FIG. 12 is an illustration of a screen for confirming an apply for purchase, which is displayed on a member terminal;

FIG. 13 is a functional block diagram of a sales management system according to a second embodiment of the present invention;

FIGS. 14A and 14B are illustrations of data items of tables stored in an article database in a second embodiment of the present invention;

FIG. 15 is an illustration of data items of a stock database in a second embodiment of the present invention;

FIG. 16 is a functional block diagram of a sales management system according to a third embodiment of the present invention;

FIG. 17 is a block diagram illustrating a networked distribution system that embodies a flexible format royalty payment method, according to one embodiment of the present invention;

FIG. 18 illustrates cost components for a typical software product that may be distributed using aspects of the present invention; and

FIG. 19 is a flow diagram that illustrates the distribution of the cost components of the software product among various entities of an e-commerce distribution system, according to one embodiment of the present invention.

### DETAILED DESCRIPTION OF THE PREFERRED EMBODIMENTS

A sales management system that performs sale by agent and a flexible license payment method for electronic commerce system is described. In the following description, for purposes of explanation, numerous specific details are set forth in order to provide an understanding of the present invention. It will be evident, however, to those of ordinary skill in the art that the present invention may be practiced without the specific details. In other instances, well-known structures and devices are shown in block diagram form to facilitate explanation. The description of preferred embodiments is not intended to limit the scope of the claims appended hereto.

The said management system in this embodiment treats, as articles, recording media such as CD-ROMs on each of which a program executable by a predetermined computer including dedicated computer is written. Since the program has an added value, a person who has developed and has the right to sell the program is called a “first added value creator”. The program is executed by the predetermined computer, whereby its functions are exhibited. Accordingly, the computer also brings an added value, and a person who has the right to produce the computer is called a “second added value creator”. Hereinafter, a “added value creator” refers to both of them, unless indicated otherwise.

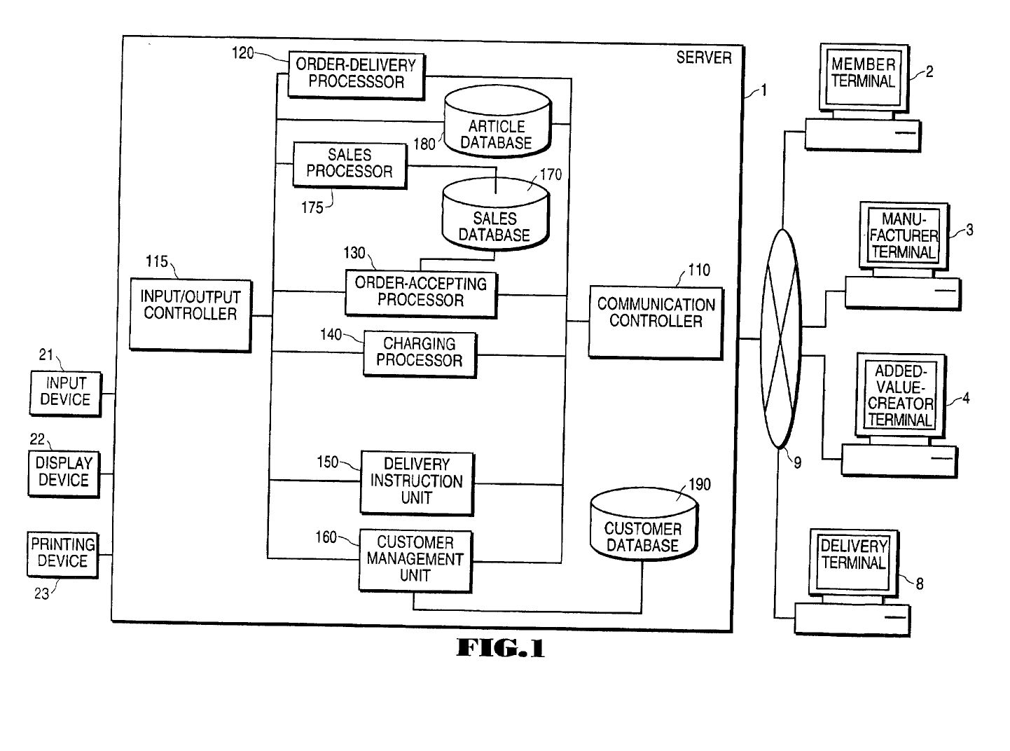

The articles are consigned for sale to a sales agent company excluding the first and second added value creators. The sales management system according to the embodiment manages operations of the sales agent company. The operations of the sales agent company includes a process from the ordering of the articles from a manufacturer up to selling of the articles to a member customer and instruction of delivery. FIG. 1 illustrates a sales management system, according to on embodiment of the present invention. The system has a sales management server (hereinafter referred to simply as a “server”) 1, a member terminal 2 used by a member of the system, an added-value-creator terminal 4 in a company of an added value creator, a manufacture terminal 5 in a company of a manufacturer that fixes software on CD-ROMs, and a delivery terminal 6 in a delivery company. These are connected via a network 9. The server 1 and the terminals do not always need to be provided in the companies, and may exist in sites on computers of the companies.

Constituted by a computer system are the server 1, the member terminal 2, the manufacture terminal 3, the added-value-creator terminal 4, and delivery terminal 8. Each configuration or function described below is achieved, for example, by executing the program.

In this embodiment, one server machine performs the entire processing in the sales management server. However, the processing by the sales management server may be distributively performed by a plurality of server machines. The articles handled by the system according to this embodiment are not limited to recording media containing programs but can also include recording media such as music CDs and DVDs (digital versatile disk) containing information having added value such as music, movies, sound, and images.

The server 1 includes, as internal functions, a communication controller 110, an input/output controller 115, a order-delivery processor 120, an order-accepting processor 130, a charging processor 140, a delivery instruction unit 150, a member management unit 160, a sales database 170, a sales processor 175, an article database 180, and a member database 190. An input device 21 such as a key board or a mouse, a display device 22 such as a CRT or a liquid crystal display, and a printing apparatus 23 such as a printer are connected to the server 1. The communication controller 110 controls communication with other terminals coupled to the network.

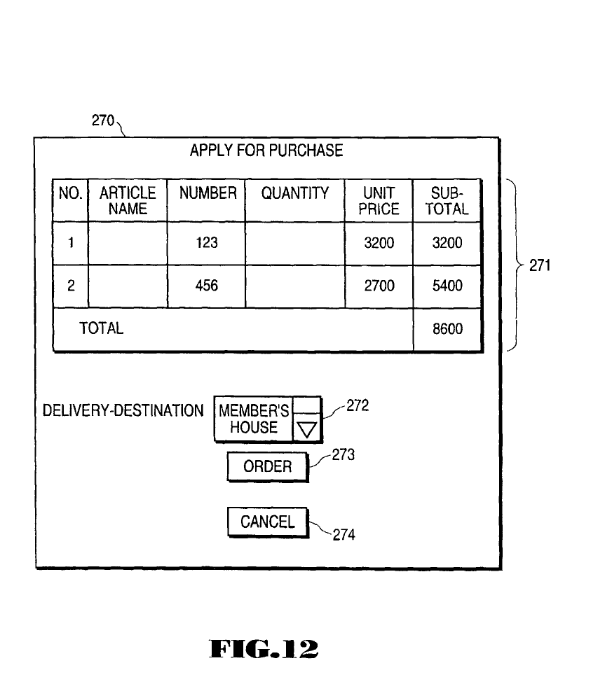

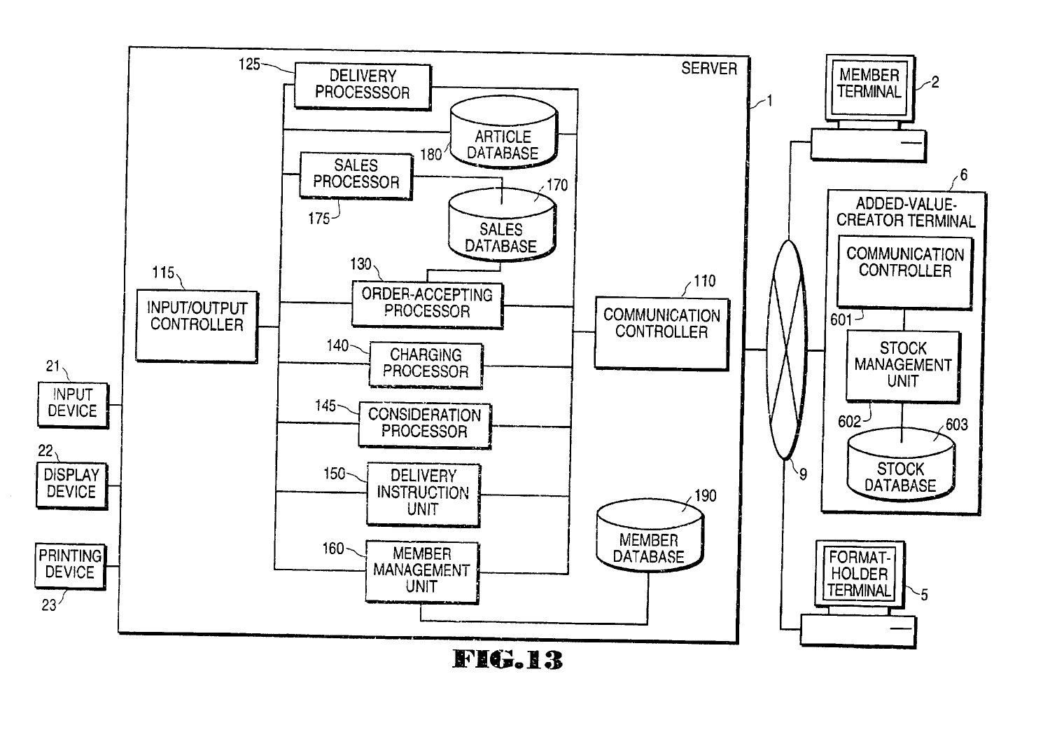

The input/output controller 115 controls inputs to and outputs from the input device 21, the display device 22, and the printing apparatus 23. In addition, the input/output controller 115 generates information for displaying a user interface screen on the member terminal 2, and it accepts information inputted through the user interface screen. Examples of the user interface screen includes, as shown in FIGS. 6 to 12, screens 210, 220, 230, 240, 250, 260, and 270.

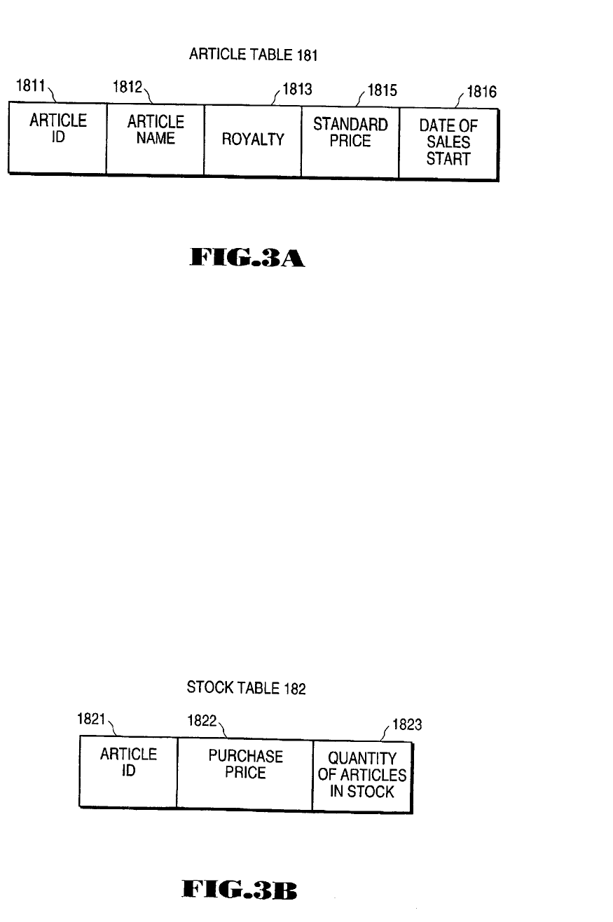

The order-delivery processor 120 performs order and delivery of articles. For example, in the order processing, the order-delivery processor generates order information from an article ID and an ordered number of articles, which are input from the input device 21, and transmits the order information to the manufacturer terminal 3. In the delivery processing, the order-delivery processor 120 receives delivery information transmitted by the manufacturer terminal 3, and adds the number of delivered articles, which is included in the delivery information, to “Number of Articles in Stock” 1823 (see FIG. 3B), whereby a stock table 182 is updated.

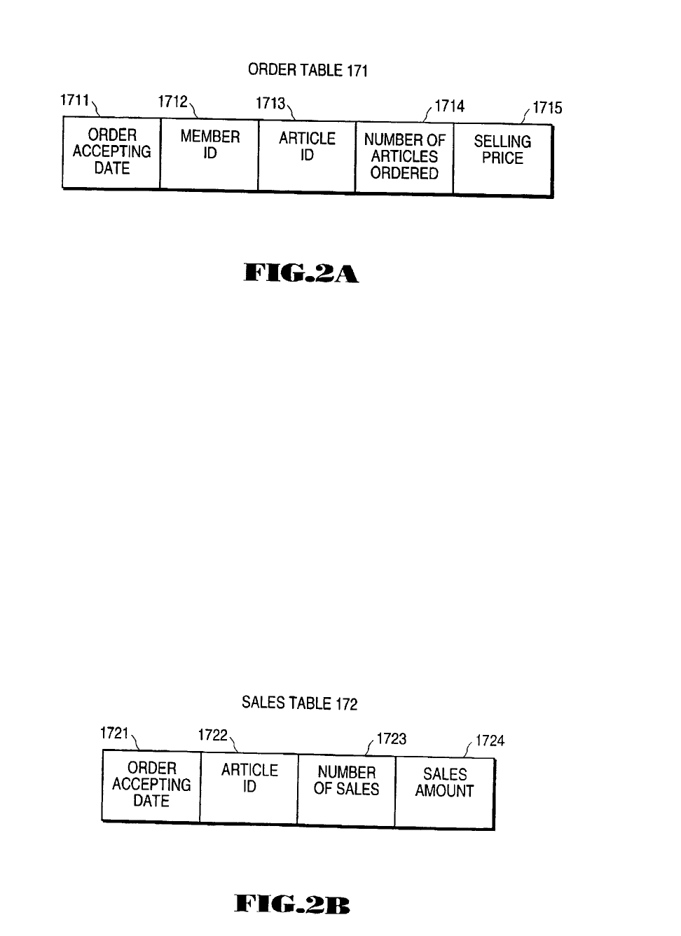

The order-accepting processor 130 receives and accepts an order from a member. Specifically, the contents of orders are stored units of transactions in an order-accepting table 171. In other words, the accepted article and number of articles are recorded in the order-accepting table 171 (see FIG. 2A), using one transaction as one record.

The order-accepting processor 130 performs a stocktaking function. Specifically, the stock table 182 (see FIG. 3B) is searched using “Article ID” 52 included in order information 50 (see FIG. 5) as a key, and the record of the Article ID 1821 is extracted. By subtracting “Number of Articles Purchased” 53 from the Number of Articles in Stock 1823, the stock table 182 is updated. In other words, the stock is reduced by the number of ordered articles.

The order-accepting processor 130 informs the delivery instruction unit 150 of the order information 50 (see FIG. 5) including “Member ID” 51, the Article ID 52, “Number of Articles Purchased” 53, and “Delivery-Destination Informnation” 54.

The charging processor 140 performs member-charging processing, and the generation and transmission of royalty information including information relating to the royalty, which is a consideration to be paid to the added value creator.

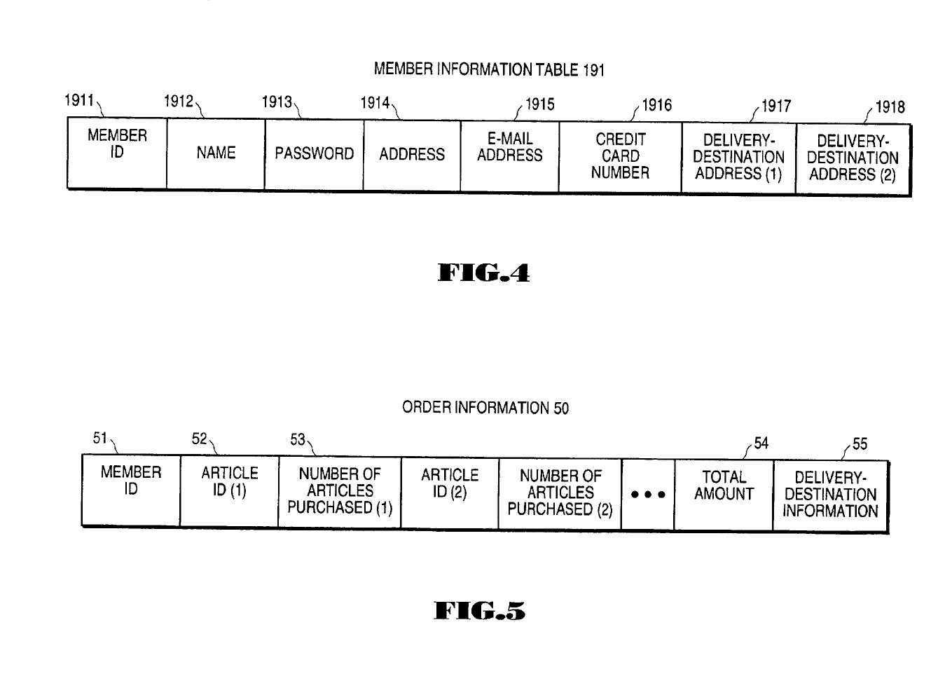

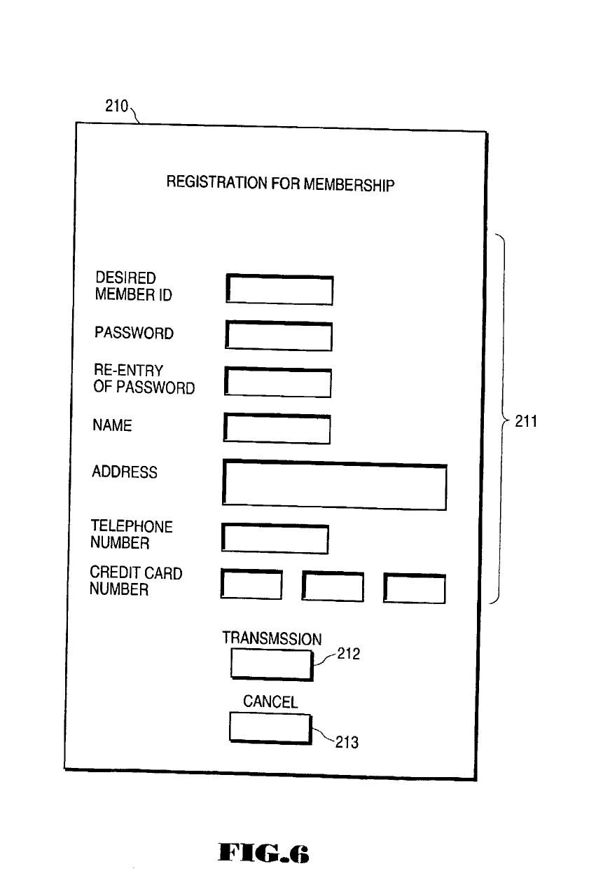

In the charging processing, specifically, a member name 1912 and a credit card number 1916, stored in a member information table 191 (see FIG. 4), are received from the member management unit 160, and these pieces of information and the total amount of money corresponding to the order are transmitted for settling the account to a computer of a credit card company, which is not shown. In addition, by outputting the information to be transmitted in the form of a list from the printing device 23, instead of transmission, the account may be settled later based on the outputted list.

A process of generating and transmitting the royalty information is specifically as follows. Royalty information that includes an article ID 1811 of the ordered article, royalty 1813 acquired from the article table, and the number of articles purchased is generated and transmitted, by the charging processor 140, to the added-value-creator terminal 4. To the first added value creator and the second added value creator, corresponding pieces of added value information are generated and transmitted.

The delivery instruction unit 150 performs delivery-instruction processing based on the information received from the order-accepting processor 130. Specifically, based on the member ID 51, the article ID 52, the number of articles purchased 53, and the delivery-destination-designating information 54, which are received from the order-accepting processor 130, delivery is instructed. For example, using the member ID 51 as a key, member information on the corresponding member is extracted from the member information table 191 (see FIG. 4) through the member management unit 160. The delivery instruction unit 150 obtains the address of a delivery destination designated by the delivery-destination-designating information 54 from the extracted member information. The delivery-destination address, the member ID, the number of articles to be delivered, and so on, are transmitted as the delivery-instruction information to the delivery terminal 8 via the communication controller 110.

The member management unit 160 manages input to and output from the member information table 191 (see FIG. 4). For example, it allows new-member recording processing, authorization processing, delivery-destination-address adding processing. Further, the member management unit 160 receives inquiries about a credit card number and a delivery-destination address at the time of charging, and so on.

By way of example, in the case of the new-member recording processing, member-recording information is received from the member terminal 2. By searching the member information table 191, it is determined whether the desired member ID and password, included in the member-recording information, has already been used by another member. After confirming no repetition about the member ID and password, a record including the member-recording information is generated and added to the member information table 191. An E-mail address may also be used as a member ID. This can omit the process of confirming repetition of a member ID.

In the authorization processing, the member information table 191 is searched using a member ID and a password as a key, which is included in a received login request, and authorization is performed based on whether member information that satisfies them is stored.

In the case of the delivery-destination-address adding processing, the delivery-destination information is received from the member terminal 2, and the delivery-destination information is added to the record stored in the member information table 191. For example, a member ID included in the delivery-destination information is used to extract member information on the corresponding member from the member information table 191, and delivery-destination information is added to this record.

The input/output controller 115 controls input to and output from the input unit 21, the display unit 22, and the printing unit 23. The sales processor 175 adds up order data recorded in the order table 171, using the Order-Accepting Date and the article ID. A result of the addition is stored in the sales table 172 (see FIG. 2B).

The sales database 170 has the order table 171 and the sales table 172, as shown in FIGS. 2A and 2B. In the order table 171, whenever an article is ordered by a member, one record is generated for one article in one transaction. The order table 171 has, for example, “Order-Accepting Date” 1711, “Member ID” 1712, “Article ID” 1713, “Number of Articles Ordered” 1714, and “Selling Price” 1715, which are data items, as shown in FIG. 2A. In the sales table 172, a result of addition obtained by the sales processor 175 is recorded. The order table 172 has, for example, “Order-Accepting Date” 1721, “Article ID” 1722, “Number of Sales” 1723, and “Sales Amount” 1724, which are data items, as shown in FIG. 2B.

The sales processor 175 performs sales processing. Specifically, the amount of sales is calculated by adding up the data in transaction units stored in the sales table 171, and is stored in the sales table 172. The sales processing may be performed at a predetermined frequency (e.g., once a day) or may be performed as required in accordance with an instruction from an operator.

The article database 180 includes an article table 181 and a stock table 182. The article table 181 has article information on each article. The article table 181 includes, for example, “Article ID” 1811, “Article Name” 1812, “Royalty” 1813, “Standard Price” 1815, and “Date of Sale Start” 1816, which are data items, as shown in FIG. 3A. The stock table 182 has information on stock of each article. The stock table 182 includes, for example, “Article ID” 1821, “Purchase Cost” 1822, and “Number of Articles in Stock” 1823, which are data items, as shown in FIG. 3B.

The member database 190 has the member information table 191. The member information table 191 stores information on members as customers. The member information table 191 includes, for example, “Member ID” 1911, “Name” 1912, “Password” 1913, “Address” 1914, “E-mail Address” 1915, “Credit Card Number” 1916, “Delivery-Destination Address (1)” 1917, and “Delivery-Destination Address (2)” 1918, as shown in FIG. 4. The Credit Card Information 1916 includes an identification information of a credit card company, a credit card number, and an expiry date.

A sales agent company orders articles from a manufacturer, based on the stocking condition of the articles and a prediction of sales of the articles. The specific process of the order processing is as follows:

An operator in the sales agent company inputs the article ID of an article to order and the number of ordered articles from the input unit 21. The order-delivery processor 120 accepts, as order information, these pieces of information input via the input/output controller 115. The order-delivery processor 120 generates an order request including the accepted order information, and transmits it to the manufacturer terminal 3.

The manufacturer terminal 3 receives the order request. The manufacturer manufactures the articles, based on the order request, and delivers the articles to the sales agent company.

Delivery from the manufacturer to the sales agent company is performed by the following process. When the manufacturer delivers the articles, the operator in the manufacturer inputs delivery information from the manufacturer terminal 3. The delivery information includes at least an article ID, the number of articles delivered, and a delivered article price. The manufacturer terminal transmits the delivery information to the server 1. Here, actual articles are not delivered to the sales agent company but are directly delivered to the warehouse company, and only the delivery information is transmitted to the server 1.

In the server 1, the order-delivery processor 120 performs the delivery processing, based on the delivery information received by the communication controller 110. Specifically, the number of articles delivered, which is included in the delivery information, is reflected in the Number of Articles in Stock 1823 of the stock table 182.

At this time, the sales agent company possesses stock of articles, and the articles in stock are sold by a process described below. The purchased cost of the articles in stock is the manufacturing cost (a) of a CD-ROM on which a program is written.

Although, in this embodiment, the above described order and delivery processing is performed by on-line processing between the server 1 and the manufacturer terminal 3, there is not always the need for the processing. In other words, it is definitely possible that an order be placed as usual, using facsimile or mail and that the operator in the sales agent company manually input the delivered article ID and the number of articles.

The system according to this embodiment is an on-line membership shopping system in which articles are sold only to members. Accordingly, a person who wishes to use the system performs membership recording. Its specific process is described below.

For example, the membership recording screen 210 shown in FIG. 6 is displayed on the member terminal 2. The membership recording user inputs membership recording information (the desired member ID, a password, a name, an address, a telephone number, credit card number, and so on) to an input field on this screen. When the user presses a transmission button 212 on finishing the input, the input membership recording information is transmitted to the server 1.

In the server 1, the member management unit 160 receives the transmission via the communication controller 110. The member management unit 160 performs new-membership recording processing based on the received membership recording information. Specifically, after confirming, with reference to the member information table 191, that no repetition occurs if membership recording with the desired member ID and password included in the membership recording information is performed, a new record which includes membership recording information is created and stored in the member information table 191. This completes the membership recording, and allows the new member to enjoy service for the members.

In order that the member may enjoy service from the server 1, the member must log in from the member terminal 2 to the server 1. The details of the login processing are described below.

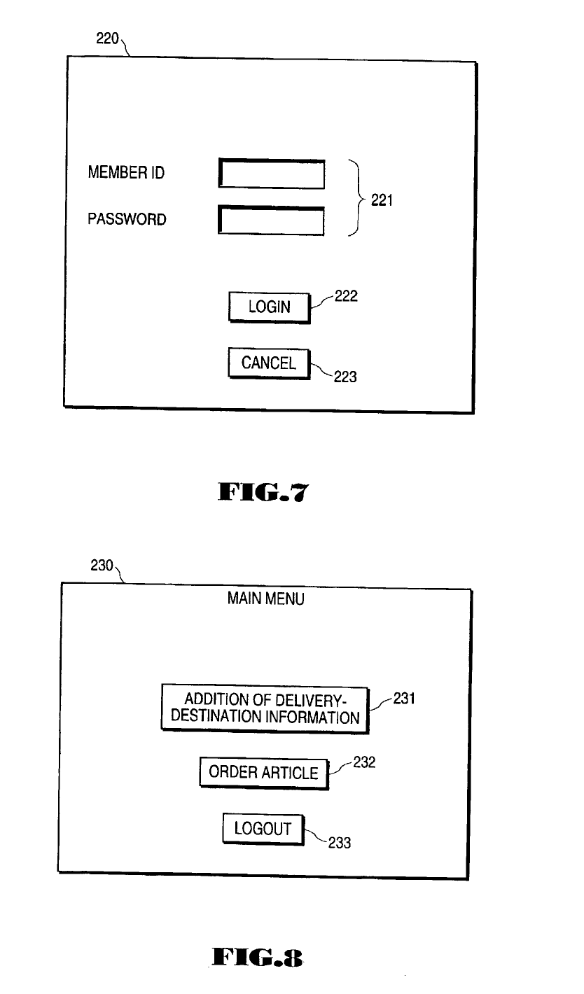

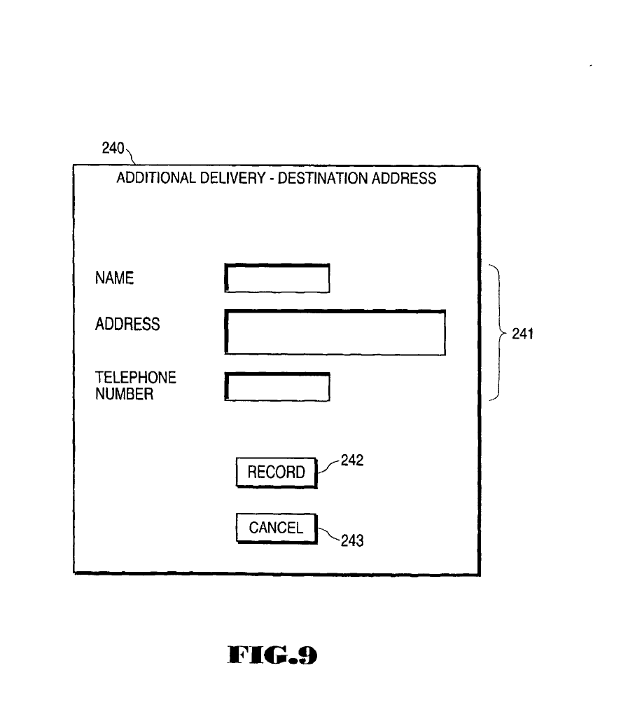

When the login screen 220 shown in FIG. 7 is displayed on the member terminal 2, the member inputs his or her member ID and password to an input field on the screen. When the login button 222 is pressed after the input, the input member ID and password is transmitted as login information to the server 1.

In the server 1, the member management unit 15, which receives the input information via the communication controller 11, performs member authorization. In other words, referring to the member information table 191, the member management unit 15 verifies whether the Member ID 1911 and the Password 1912 coincide with those recorded. As a result of the verification, when coincidence is obtained, login is permitted, and when no coincidence is obtained, login is not permitted.

When the login is permitted, the main menu screen 230 shown in FIG. 8 is displayed on the member terminal 2. Service provided to the member in the login condition is described below.

In this system, an article purchased by the member is delivered. The delivery destination is normally a member's house. However, considering that the member desires delivery to a place different from the member's house, the address of a place different from the member's house may be input.

When an “Additional Delivery-Destination Information” button 231 on the main menu screen is pressed, the “Additional Delivery-Destination Address” screen 240 shown in FIG. 9 is displayed on the member terminal 2. The member inputs the delivery-destination address to an input field 241 on this screen. When a “Record” button 242 is pressed after completing the input, the inputted delivery-destination information is transmitted to the server 1.

In the server l, the member management unit 160 receives the transmission via the communication controller 110, as in the membership recording. Based on the received delivery-destination information, the member management unit 160 records the additional delivery-destination address in the member information table 191.

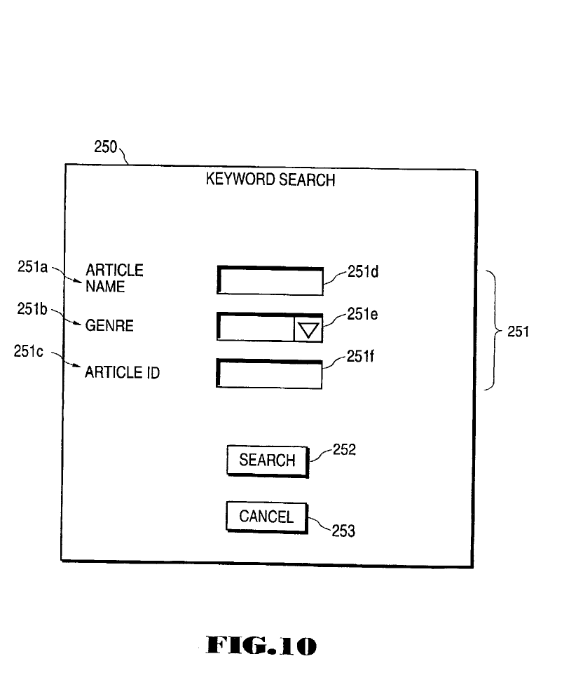

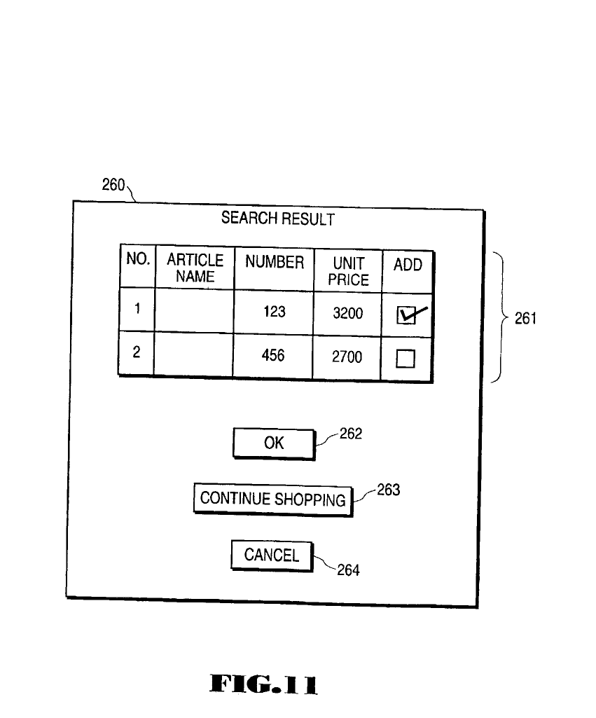

Next, a process in which the member orders an article and the sales agent company accepts it is described. When an “Order Article” button 232 on the main menu screen is pressed, the article search screen 250 shown in FIG. 10 is displayed on the member terminal 2. The member inputs information on the desired article to an input field 251 on the screen. For example, “Article Name” 251a or “Article ID” 251c is inputted, or “Genre” 251b is selected from a pulldown list 251e. When a “Search” execution button 252 is pressed after inputting search conditions, a search request is transmitted to the server 1. The communication controller 110 in the server 1 receives the request, and a search engine (not shown) performs search. A result of the search is sent back to the member terminal 2. The member terminal 2, which receives the search result, displays the “Search Result” screen 260 shown in FIG. 11.

On this screen, the member checks a check box 261 for an additionally desired article. When an “OK” button 262 is pressed, an “Apply for Purchase” screen 270 is displayed on the member terminal 2 so that the member can finally confirm the article to order. By pressing a “Continue Shopping” button 263, the search screen 250 is displayed again, enabling a re-search.

In addition to the above-described form in which the member searches for an article to purchase, a form in which the member directly inputs an article name, and so on, and a form in which an article list is displayed for the member so that the member can select from the list, may be used.

A confirmation screen, displayed before the member finally gives an order after selecting the desired article, is the “Apply for Purchase” screen 270 shown in FIG. 10. The member uses this screen to confirm articles to order, the number of articles, and a delivery destination.

The delivery destination is set as the member's house, but the member may wish delivery to a place different from the member's house. Accordingly, a pre-recorded delivery destination different from the member's house can be selected from a delivery-destination designating pulldown list 272. Information displayed on the pulldown list 272 is acquired from the member information of the member stored in the member information table 191, and is displayed.

When the member presses an “Order” button 273 after confusing the contents of the order, the order information 50 is transmitted from the member terminal 2 to the server 1. The order information 50 includes, for example, “Member ID” 51, “Article ID” 52, “Number OF Articles Purchased” 53, “Total Amount” 54, and “Delivery-Destination Information” 55, as shown in FIG. 5. When a plurality of types of articles are simultaneously ordered, sets of the Article ID 52 and the Number of Articles Purchased 53, which correspond to the types, are included.

Next, the stocktaking processing, performed by the server 1 when it accepts the order information 50 from the member, is described. The order-accepting processor 130 accepts the order information 50 via the communication controller 110, and performs stocktaking processing based on the order information 50. Specifically, among the stock data stored in the stock table 182, from the Number of Articles in Stock 1823, the number of articles ordered is subtracted, whereby the stock table 182 is updated.

The order-accepting processor 130 adds the contents of the order information 50 to the order-accepting table 171. In other words, the ordered articles and the number of articles are recorded as a history.

After the stocktaking processing, the charging processor 140 performs charging. Specifically, it is performed by the following process. In this system, a payment is made using a credit card. In the member information table 190, a credit card number corresponding to each member is stored. In accordance with a request from the charging processor 140, the member management unit 160 uses the Member ID 1911 as a key to extract the Member Name 1912 and the Credit Card Number 1916 from the member information stored in the member information table 191. The charging processor 140 receives the extracted information, and accumulates the extracted information and the Total Amount 54 (amount of charge) which is included in the order information 50. The charging processor 140 periodically transmits the accumulations to a credit card company for settlement of accounts. Also, a list is outputted from the printing unit 23, and accounts are settled later, based on the output list.

The charging processor 140 further transmits royalty information to the added-value-creator terminal 4. The royalty information includes, for example, the article ID of the ordered article and the amount of a royalty which must be paid to the added value creator. Transmission of the royalty information may be performed in units of transactions whenever each order is accepted or may be performed at the same time when a certain number of orders are accepted. Moreover, the transmission may periodically be performed.

By transmitting an article ID and the number of articles sold, instead of the royalty information including the amount of the royalty, the royalty may be calculated at the added-value-creator end.

The royalty (b) is generated at an order accepting stage. Thus, while the sales agent company possesses articles as a stock, the value of the stock remains the manufacturing cost (a). Accordingly, the price of each article in stock is lower than usual. This reduces the stocking burden to the sales agent company, and large financial merits are obtained. In addition, when a stock having a financial amount identical to the conventional amount are held, the number of articles in stock greatly increases, which reduces the risk that the articles are out of stock and selling opportunities are lost.

In this embodiment, the first added value creator may bear the manufacturing cost (a) and may entrust the sales agent company with the sale of articles. In this case, the articles are a stock of the first added value creator, and the sales agent company does not have any stock.

When the charging processing is completed, the delivery instruction unit 150 performs delivery instruction processing in accordance with a notification of the completion.

The delivery instruction unit 150 receives, as delivery information, the Member ID 51, the delivery-destination designating information, the article ID, and the numbers of articles, etc., from the order-accepting processor 130, which are included in the order information 50. By using a member ID included in the delivery information as a key, member information on the corresponding member is extracted from the member information table 191 via the member management unit 160. The address of the delivery destination designated in the extracted member information is acquired.

The delivery-destination address, the article ID, the number of articles to be delivered, and so on, are transmitted as delivery-destination designating information to the delivery terminal 8 via the communication controller 110. The delivery company that has the delivery terminal 8 delivers the articles, based on the received delivery-destination designating information.

Although, in this embodiment, the delivery instruction is performed by on-line processing between the server 1 and the delivery terminal 8, there is not always the need for the processing. In other words, it is possible that the delivery-destination instruction information is printed out from the printing unit 23 so that the operator in the sales agent company instructs the delivery company by telephone.

Next, a sales management system according to a second embodiment of the present invention is described below. Description may be omitted concerning the functions or configurations identical to those of the first embodiment, by using same reference numbers. The sales management system in this embodiment treats, as articles, recording media such as CD-ROMs on each of which a program executable by a predetermined computer including dedicated computer is written. Since the program has an added value, a person who has developed and has the right to sell the program is called an “added value creator”. The “added value creator” of this embodiment corresponds to the “first added value creator” of the first embodiment. The program is executed by the predetermined computer, whereby its functions are exhibited. Accordingly, when the program is sold, the added value creator must pay a consideration based on intellectual property right relating to the computer, that is, a royalty, to the developer of the computer. A person who has the intellectual property right relating to the computer and to whom the royalty is paid is called a “format holder”. The “format holder” of this embodiment corresponds to the “second added value creator” of the first embodiment.

Concerning the articles, sales management is performed by a third party other than the added value creator and the format holder. The third party is hereinafter referred to as the “sales manager”. When the sales manager purchases, for sale, articles from the added value creator, the purchase price is represented by P. The purchase price P is, that is, a price at which the added value creator sells to the sales manager. The purchase price P includes a manufacturing cost (hereinafter referred to simply as a “manufacturing cost”) (a′) of CD-ROMs as articles and a royalty (c′) that must be paid by the added value creator to the format holder. Accordingly, an amount (P−a′−c′) obtained by subtracting the manufacturing cost (a′) and the royalty (c′) from P is the consideration (b′) corresponding to the added value, which is to be paid to the added value creator.

The sales management system according to this embodiment manages operations of the sales manager. The operations of the sales agent company includes a process from the ordering of the articles from a manufacturer up to selling of the articles to a member customer and instruction of delivery.

This system, as shown in FIG. 13, includes a sales management server 1 and an added-value-creator terminal 6. In this system, a member terminal used 2 by a member of the system and a format-holder terminal 5 are connected via a network 9. The server 1 and the terminals do not always need to be provided in the corresponding companies, etc., but may exist in sites of computers in the companies, etc.

In this embodiment, one server machine performs the entire processing in the sales management server. However, the processing by the sales management server may be distributively performed by a plurality of server machines. The articles handled by the system according to this embodiment are not limited not only to recording media containing programs but also to recording media such as music CDs and DVDs (digital versatile disk) containing information having added value such as music, movies, sound, and images.

The server 1 includes, as internal functions, a communication controller 110, an input/output controller 115, a delivery processor 125, an order-accepting processor 130, a charging processor 140, a consideration processor 145, a delivery instruction unit 150, a member management unit 160, a sales database 170, a sales processor 175, an article database 180, and a member database 190. An input device 21 such as a key board or a mouse, a display device 22 such as a CRT or a liquid crystal display, and a printing apparatus 23 such as a printer are connected to the server 1.

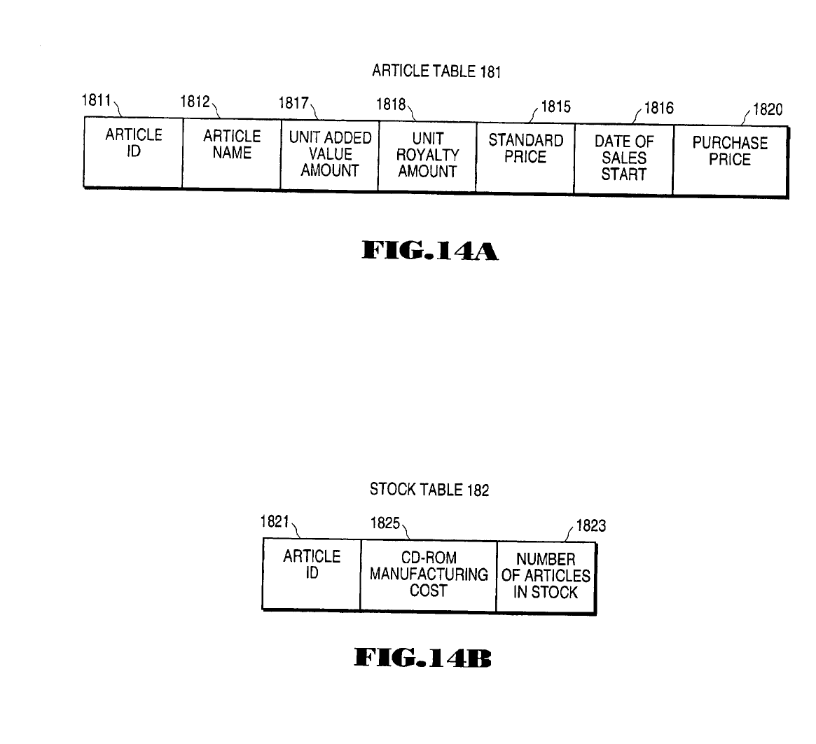

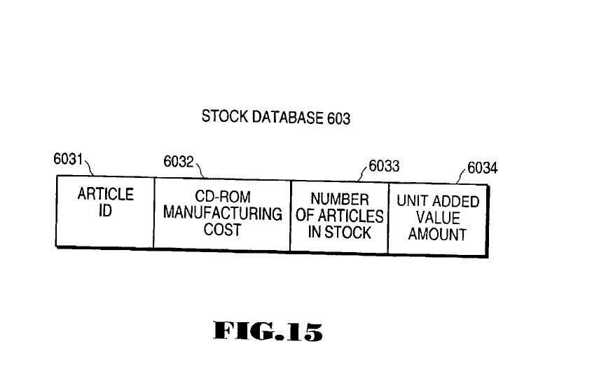

The delivery processor 125 performs delivery of articles. For example, it receives delivery information transmitted from the added-value-creator terminal 6, and updates, based on the delivery information, “CD-ROM Manufacturing Cost” 1822 and “Number of Articles in Stock” 1823 (see FIG. 14) in a stock table 182.

The consideration processor 145 calculates, for each article, the amount of a consideration per article to be paid to the added value creator or the format holder, and generates consideration information to be transmitted to the added-value-creator terminal 6 and the format holder terminal 5.

In the case where the amount of a consideration (hereinafter referred to a “unit added value amount”) (b′) corresponding to added value per article, which must be paid to the added value creator, is determined, the amount of a royalty per article (hereinafter referred to a “unit royalty amount”), which must be paid to the format holder, is calculated by, for example, the following manner. In other words, by using the Article ID as a key, the article manufacturing cost 1825 (a′) (see FIG. 14) stored in the stock table 182 and “Unit Added Value Amount” (b′) 1817 (see FIG. 14) stored in the article table 181 are acquired. Based on a predetermined numerical expression, the unit royalty amount (c′) is calculated. The calculated unit royalty amount is stored in the article table 181. It is possible that an expression for the calculation of the unit royalty amount is, for example, several percent of (a′+b′).

In addition, in the case where a purchase price (P) which is the sum of the manufacturing cost (a′), the unit added value amount (b′), and the unit royalty amount (c′) is determined, based on a predetermined numerical expression, the unit royalty amount may be calculated and stored in the stock table 181. For example, letting the unit royalty amount (c′) be several percent of the purchase price (P), also the unit added value amount (b′) can be calculated.

The generation and transmission of the consideration information is performed by, for example, the following manner. In other words, from the “Article ID” 1811 of the ordered article, “Unit Added Value Amount” 1817 acquired from the article table, “Unit Royalty Amount” 1818, and the number of ordered articles, consideration information to the added value creator and consideration information to the format holder are generated. The pieces of consideration information are transmitted to the added-value-creator terminal 6 and the format holder terminal 5, respectively. Here, the consideration information includes information for the added value creator to know a consideration corresponding to added value concerning the ordered article or the amount of the royalty. For example, the consideration information may include the Article ID and the number of ordered articles. In this case, the added-value-creator terminal 6 holds the unit added value amount, and the format holder terminal 5 holds the unit royalty amount. By using these amounts, a total of the consideration to the added value and the royalty may be found. The consideration information may include “Unit Added Value Amount” and “Unit Royalty Amount” in addition to the Article ID and the number of ordered articles. Otherwise, the consideration information may include a total of considerations to the added value or royalties calculated based on the Article ID and the number of ordered articles at the server 1. The consideration information may include the Article ID, the number of ordered articles, and the purchase price.

The article database 180 includes an article table 181 and a stock table 182. The article table 181 has article information on each article. The article table 181 includes, for example, “Article ID” 1811, “Article Name” 1812, “Unit Added Value Amount” (b′) 1817, “Unit Royalty Amount” (c′) 1818, “Standard Price” 1815, “Date of Sale Start” 1816, and “Purchase Price” 1820, which are data items, as shown in FIG. 14A. The Unit Added Value Amount 1817 is determined between the sales management company and the added value creator, or is calculated and stored by the consideration processor 145. The Unit Royalty Amount 1818 is calculated and stored by the consideration processor 145.

The stock table 182 has information on stock of each article. The stock table 182 includes, for example, “Article ID” 1821, “CD-ROM Manufacturing Cost” 1825, and “Number of Article in Stock” 1823, which are data items, as shown in FIG. 14B.

The added-value-creator terminal 6 includes a communication controller 601, a stock management unit 602, and a stock database 603. The communication controller 601 controls communication with the server 1, and other terminals coupled to the network.

The stock database 603 includes “Article ID” 6031, “CD-ROM Manufacturing Cost” 6032, “Number of Articles in Stock” 6033, and “Unit Added Value Amount” 6034 as data items, as shown in FIG. 15. The stock management unit 602 controls input to and output from the stock database 603, calculates the number of unsold articles and the royalty amount, etc.

The stock management unit 602 increases the Number of Articles in Stock 6033 when receiving delivery information from what is entrusted with manufacture of articles, for example, the format holder terminal 5, and reducing the Number of Articles in Stock 6033 when receiving a notification of the number of ordered articles from the server 1.

From the Manufacturing Cost 6032 and the Number of Articles in Stock 6033, the number of unsold articles is calculated. When the stock management unit 602 receives a notification of the number of ordered articles, it can calculate, from the number of ordered articles and the Unit Added Value Amount 6034, a total of considerations to added values caused by sales, that is, income. Calculation of the number of unsold articles and the royalty amount may be arbitrarily performed, and may periodically be performed.

General computers that have a CPU, a main storage device, an auxiliary storage device, input and output devices, etc., can be used as the member terminal 2 and the format holder terminal 5. The storage unit may store in the auxiliary storage device a communication program for establishing a link to the server 1, a screen control program for displaying an interface screen on the display unit, etc. Screen data may be stored in the auxiliary storage device. Also by downloading the screen data from the server 1, as required, the data may be displayed on the display unit.

Processing by the system according to the embodiment is described below. First, a process in the case where articles are delivered to the sales manager is described. The added value creator orders articles from what is entrusted with manufacture, for example, the format holder. The format holder delivers the articles manufactured in accordance with the order to the added value creator. A manufacturing cost that must be paid by the added value creator is a manufacturing cost (a′) as a material price of CD-ROMs. Actual articles are delivered and managed by the sales manager. Accordingly, one that pays the manufacturing cost of the articles and that keeps a financial stock of articles is the added value creator. At this time, the added value creator possesses articles in stock which have value (a′).

In the system according to this embodiment, the above-described delivery processing is performed by the following specific manner. When the articles are delivered from the format holder to the sales manager, delivery information that includes at least an article ID, the number of delivered articles, and the manufacturing cost is transmitted from the format holder terminal 5 to the server 1 and the added-value-creator terminal 6.

In the server 1, based on the delivery information received by the communication controller 110, the delivery processor 125 performs delivery processing. For example, the Number of Articles in Stock 1823 is updated using the Article ID 1821 and the Manufacturing Cost 1822 of the stock table 182 as keys. Also in the added-value-creator terminal 6, the stock database 603 is similarly updated.

Although, in this embodiment, the above-described delivery processing is performed by on-line processing there is not always the need for the processing. In other words, it is definitely possible that an order be placed as usual, using telephone, facsimile, mail or the like, and that an operator for the sales manager manually inputs the delivered article ID, the number of articles, and the manufacturing cost for the order from the input device 21, etc.

Before starting the sale of articles, the unit royalty amount is determined. In other words, between the added value creator and the sales manager, a total (a′+b′+c′) of the manufacturing cost corresponding to the purchase price at the sales manager, the unit added value amount, and the unit royalty amount, or the unit added value amount (b′), is determined. When the purchase price or the unit added value amount is inputted from the input device 21, the consideration processor 145 calculates the unit added value amount or the unit royalty amount, etc. and stores them in the article table 181 with the purchase price. The unit added value amount and the unit royalty amount may be calculated whenever an order is accepted.

The system, shown in FIG. 13, is an on-line membership shopping system in which articles are sold only to members. The system of this embodiment overlaps that of the first embodiment in member-recording procedure and other various processes for using the system such as login, addition of delivery-destination address and order. Thus, description on these common parts will be omitted, and different parts from the first embodiment will mainly be described.

The server 1, as in the first embodiment, receives the order information 50 from the member terminal 2. Based on the order information 50, the order-accepting processor performs stocktaking processing. After the stocktaking processing, the charging processor 140 conducts charging processing.

The price of an article to be sold to the members is determined in accordance with the total of the manufacturing cost (a′), the unit added value amount (b′), and the unit royalty amount (c′) by the sales manager, and is displayed to the members. Here, the purchase price (a′+b′+c′) is determined beforehand between the added value creator and the sales manager, and is stored in the article table 181. From the purchase price 1820, the unit added value amount (b′) and the unit royalty amount (c′) are determined as described above.

After the charging processor 140 performs charging processing, the consideration processor 145 transmits pieces of consideration information to the added-value-creator terminal 6 and the format holder terminal 5. The transmission of the consideration information may be performed in units of transactions whenever each order is accepted, and may be performed corresponding to a plurality of orders. Also, it may periodically be performed at predetermined intervals. Based on the consideration information, the sales manager pays a consideration to the added value creator in accordance with the number of accepted orders, and the sales manager pays a royalty instead of the added value creator.

The consideration processor 145 transmits the consideration information only to the added-value-creator terminal 6 but may not transmit to the format holder. In this case, the added value creator notifies the format holder of the unit royalty amount (c′) at another time. At the time, the sales manager pays the sum of the consideration to the added value and the royalty to the added value creator.

Either the above-described charging processing or the consideration processing may be performed first. In other words, when the consideration processing is performed first, articles are sold to the members financially after the sales management company purchases the articles from the added value creator.

In this embodiment, added value is generated when an order is accepted, or sale is performed just after added value is generated. Thus, while the sales manager keeps the articles in stock, the value of the stock substantially remains the manufacturing cost (a′). The value per article in stock becomes lower than conventional. Accordingly, the stocking burden in the added value creator is reduced and financial merits are large. In addition, when a stock having a financial amount identical to the conventional amount are held, the number of articles in stock greatly increases, which reduces the risk that the articles are out of stock and selling opportunities are lost. The sales manager can sell articles in substantially having almost no stock.

When the charging processing and the consideration processing are completed, the delivery instruction unit 150 performs delivery instruction processing in accordance with a notification of the completion.

As described above, according to the system of this embodiment, sales of recording media on each of which information such as a program and music is recorded can be managed. In addition, according to the sales method in this embodiment, a sales manager can perform selling without any articles in stock. Although the added value creator must have a stock, the stocking burden is small because the value of the stock can be controlled to be small. Although an increased number of articles in stock increases the stocking burden, the stocking burden is smaller than usual because stocking burden per article is reduced.

Next, a sales management system according to a third embodiment of the present invention is described below. Description may be omitted concerning the functions or configurations identical to those of the first and second embodiments, by using same reference numbers. The sales management system according to the third embodiment of the present invention handles, as articles, digital-encoded information or recording media having the digital-encoded information recorded thereon. Examples of the article includes a program executable by a predetermined computer including dedicated hardware, recording media such as CD-ROMs on which the program is written, music CDs, digital information such as music, movies, sound, and images, and DVDs (digital Versatile Disk) having these recorded thereon. When the information itself is sold as articles, it is distributed via a network.

Here, these intangible information contents have an inherent added value, and thus a person who has developed, created, or written the contents and has the right to sell them is called an “added value creator”. The “added value creator” of this embodiment corresponds to the “first added value creator” of the first embodiment and the “added value creator” of the second embodiment. The program is executed by the predetermined computer, whereby its functions are exhibited. Accordingly, when the program is sold, the added value creator must pay a consideration base on intellectual property right relating to the computer, that is, a royalty, to the developer of the computer. A person who has the intellectual property right relating to the computer and the computer and to whom the royalty is paid is called a “format holder”. The “format holder” of this embodiment corresponds to the “second added value creator” of the first embodiment and the “format holder” of the second embodiment.

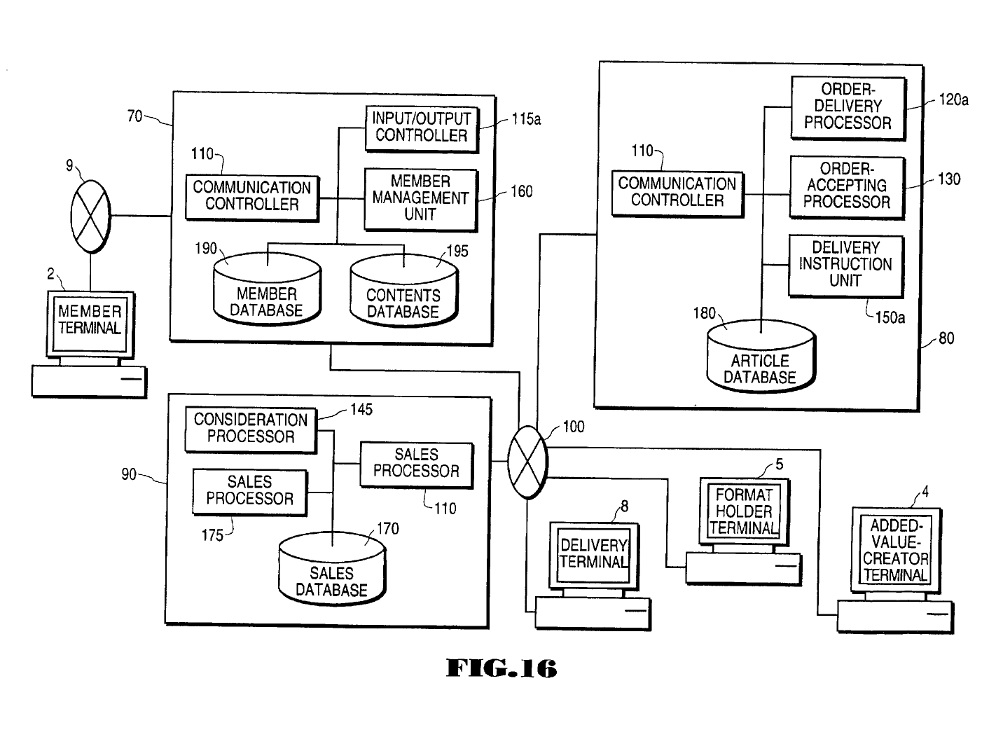

Concerning the articles, sales management is conducted by a third party other than the added value creator and the format holder. The third party is hereinafter referred to as the “sales manager”. The sales management system according to this embodiment, as shown in FIG. 16, includes a web server 70, a distribution server 80, and sales management server 90. This sales management system has an added value creator terminal 4, a format holder terminal 5, and delivery terminal 8 connected thereto. The above-mentioned servers and terminals are connected with each other via the Internet, for example, an extra-net 100. The web server 70 is connected the member terminal 2 via a network such as the Internet.

The web server 70 has a communication controller 110, an input/output controller 115a, a member management unit 160, a member database 190, and a contents database 195. In the web server 70, member management such as member-recording and login processing is performed.

The contents database 195 stores digitized information to be distributed as articles. For instance, stored thereon are digital information such as computer programs, music, movies, sound, and images by corresponding to an article ID.

The input/output controller 115a, in addition to the functions described in the first embodiment, distributes digital information via a network. For example, distribution information such as a member ID and an article ID is received and outputted to the network for distributing contents specified by the article ID to the member specified by the member ID.

The distribution server 80 includes a communication controller 110, an order-delivery processor 120a, an order-accepting processor 130, delivery instruction unit 150a, and an article database 180. The order-delivery processor 120a performs, when recording media is handled as articles, purchase processing as well as order processing and delivery processing. In the order processing, the order-delivery processor 120a informs the added value creator terminal 4 of identification information and the number of ordered article. In the delivery processing, the order-delivery processor 120a updates the stock table 182 after receiving a notice from the added value creator terminal 4. In the purchase processing the order-delivery processor 120a performs on account book purchase processing. By doing this, the ownership of articles is transferred from the added value creator to a vendor.

The delivery instruction unit 150 provides, in addition to the functions described in the first embodiment, a delivery instruction by receiving a notice from the added value creator terminal 4 or the delivery terminal 8. The delivery instruction unit 150a notifies the sales management server 90 of shipping information after delivery instruction. This shipping information includes, for example, a member ID 51, an article ID 52 and the number of purchased articles 53. In the case that digital information is distributed via a network, the delivery instruction unit 150 notifies, instead of providing delivery instruction to the delivery terminal 8, the input/output controller 115a of distribution information including the member ID 51 and the article ID 52 for distribution.

The sales management server 90 has a communication controller 110, a consideration processor 145, a sales processing unit 175, and a sales database 170.

The system shown in FIG. 16 is, like the first and second embodiments, an online membership shopping system. The system of this embodiment overlaps those of the first and second embodiments in member-recording procedure and other various processes for using the system such as login, addition of delivery-destination address, and order. Thus, description on these common parts will be omitted, and parts inherent to this embodiment will mainly be described.

First, when a recording medium is handled as an article, a processing procedure therefor will be described below. The communication controller 110 of the web server 70 receives the order information 50 from the member terminal 2 and outputs it for transfer to the distribution server 80. At the distribution server 80, the order-delivery processor 120a places an order for an article with the added value creator terminal 4.

From the added value creator who receives the order, the article arrives at a predetermined warehouse not shown. When delivery becomes possible after the article is received, the delivery instruction unit 150a provides a delivery instruction with a delivery company and transmits shipping information to the sales management server 90. The purchase processing at the order-delivery processor 120a, may be performed at either timing of when articles are replenished or when the shipping information is outputted.

At the sales management server 90, the sales processor 175 conducts sales processing by receiving the shipping information. For example, as in the first embodiment, the consideration processor 145 acquires the royalty 1813 from the preliminary prepared article table 181, generates a royalty information from the royalty 1813 and the number of shipped articles included in the shipping information, transmitting it to the added value creator terminal 4. Alternatively, as in the second embodiment, the consideration processor 145 acquires a purchase price 1820 stored in the article table 180 using an article identification information, thereby generating the royalty information. The order-delivery processor 120a receives a notice at a time of performing the purchase processing, and the consideration processor 145 may perform consideration processing by use of the order information including the article identification information and the number of ordered articles. This processing procedure allows the vendor to substantially conduct sales without stock.

In another processing procedure, the order-delivery processor 120a places an order for an article before receiving an order from a member, and then performs purchase processing. In this case, the vendor has stock, and sells an article in stock after receiving an order. Then, the consideration processing can be performed using the order information transmitted to the added value creator.

Further, in still another processing procedure, the sales processor 175 performs sales processing at a time of accepting an order of articles. Thereafter, the delivery instruction unit 150a provides an instruction for delivery of the articles already existing in stock. Otherwise, the order-delivery processor 120a places another order, and then an instruction may be provided for delivery of the received articles.

Next, when information itself is handled as an article and distributed via a network, a processing procedure therefor different from one for a recording medium will mainly be described below. In the case of distribution via a network, delivery by a distributor is not necessary. Thus, instead of delivery instruction, the delivery instruction unit 150a provides a distribution instruction with the input/output controller 115a of the web server 70. The input/output controller 115a distributes digital information to the member terminal 2. The order and delivery processing may be performed only when the contents database 19 does not have contents which is ordered for distribution. Moreover, when accepting an order or instructing distribution, the sales processor 175 the consideration processor 145 may perform sales processing and consideration processing, respectively, at the sales management server 90.

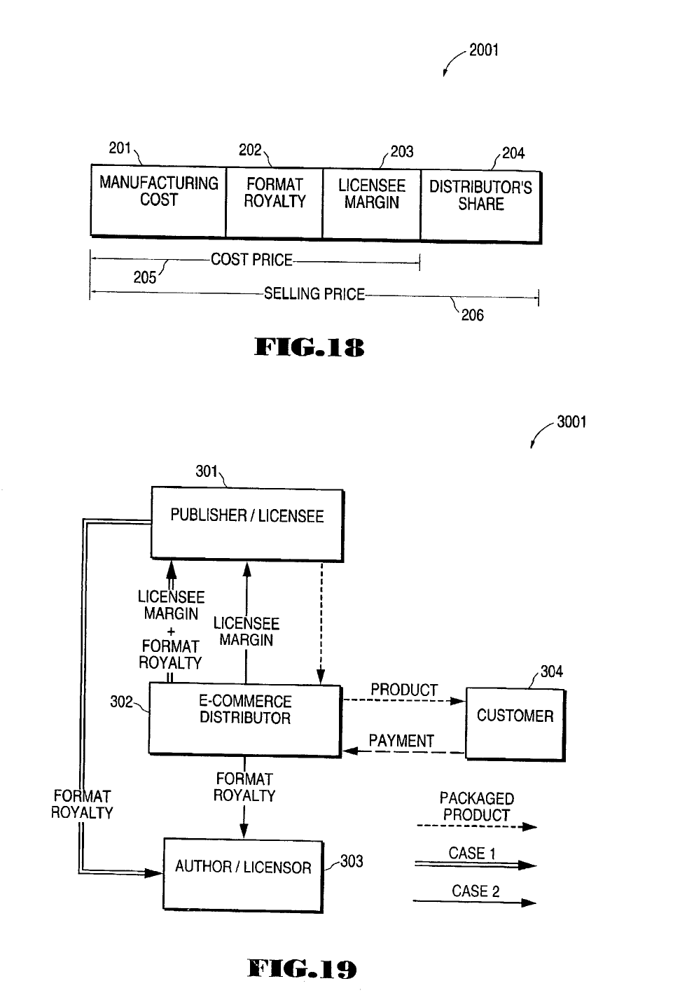

According to an alternative embodiment of the present invention, a flexible royalty payment system is implemented. For distributed software products, the ultimate cost of a program or product is typically composed of various cost elements. FIG. 18 illustrates a cost component table 2001 of a typical software product. The total selling price 206 of the product comprises a manufacturing cost 201, a format royalty 202, a licensee margin 203, and a distributor share 204.

The manufacturing cost 201 represents the cost required to make the software and represents actual production costs as well as amortized research and development costs, and other similar cost items. The format royalty 202 represents a royalty cost or license fee that the publisher of the software is required to pay to the software developer or creator of the program (author). The format royalty 202 is typically a percentage value of the cost price, for example a typical format royalty may be determined to be 20% of the cost price. The licensee margin 203 represents the profit margin reserved for the licensee, who is typically the publisher of the software. Together, the manufacturing cost 201, format royalty 202, and licensee margin 203 comprise the cost price 205 of the software product. This corresponds to the “wholesale” price of the product, and together with the distributor share 204 that the distributor of the product charges, makes up the total selling price 206 charged to the customer. In the case where the customer is the end consumer, the total selling price 206 is defined as a retail price that also includes other costs, such as a retailer margin. In general, the cost price 205 is determined for every different software product that a licensee or manufacturer may provide.

In present software distribution systems, a software publisher who publishes a program or product for a particular format, for example a CD-ROM based computer game for a particular game platform, typically pays a format royalty to the game author (licensor). This royalty is usually paid up-front for a particular production volume to cover all of the products published by the publisher, regardless of whether the publisher actually sells any or all of the products. Thus, a publisher typically has to absorb the royalty cost even for items that are not sold.

In one embodiment of the present invention, a flexible format royalty payment system is implemented. This system facilitates the payment of a format royalty by the publisher for products that are actually sold, and thus helps to defer payments until the product is sold and prevents undue royalty costs to the publisher for unsold product. An e-commerce distribution system, centered on an c-commerce distribution server computer routes the payment of the format royalty and the other appropriate cost components illustrated in FIG. 18, among the entities in the system. FIG. 19 is a flow diagram that illustrates the various entities and the cost components for a product produced and distributed by these entities. For the flow diagram 3001 of FIG. 19, an author or manufacturer (licensor) 303 of a software product creates the software for use by a customer 304. A publisher (licensee) 301 produces the software product and distributes the product to the customer 304 through an e-commerce distributor 302. The distributor 302 sends the product to the customer 304. In return, the customer 304 pays the selling price 206 to the distributor 302, either directly or through a retailer.

For the embodiment illustrated in FIG. 19, the selling price of the product is paid by the customer 304 and is received by the distributor 302. As illustrated in FIG. 18, the selling price 206 includes several cost components that need to be paid to the respective parties in the system.

In one embodiment of the present invention, denoted “Case 1” in FIG. 19, e-commerce distributor 302 receives the selling price payment from the customer 304. The e-commerce distributor 302 then pays the licensee margin amount 203 and format royalty amount 202 to the publisher 301. The distributor 302 keeps a portion corresponding to the distributor's share 204 for the transaction. The publisher 301 then sends the format royalty payment 202 to the author 303. The portion of the cost price 205 corresponding to the manufacturing cost 201 and licensee margin 203 are kept by the publisher 301.

In an alternative embodiment of the present invention, denoted “Case 2” in FIG. 19, the distributor 302 deputizes the format royalty payment on behalf of the publisher 301. For this embodiment, the e-commerce distributor 302 receives the selling price payment from the customer, and then pays the licensee margin 203 to the publisher 301, and the format royalty 202 directly to the author 303. This embodiment prevents the need for the publisher to pay the format royalty to the author. For both embodiments illustrated in FIG. 3, the format royalty 202 is not paid to the author 303 until the product is provided to and/or paid for by the customer 304.

It should be noted that the format royalty 202 can be calculated by any means agreed to by the publisher and author. For example, the format royalty 202 can be a set percentage of the cost price 205, selling price 206, or an absolute amount, or any other mutually agreed upon value. The format royalty can also be a graduated value, weighted on the number of products sold, the age of the product, and other such factors. For the embodiment illustrated in FIG. 19, as Case 2, in which the e-commerce distributor 302 sends the format royalty payment to the author, the distributor is informed of the format royalty calculation so that the proper amount can be remitted to the author.

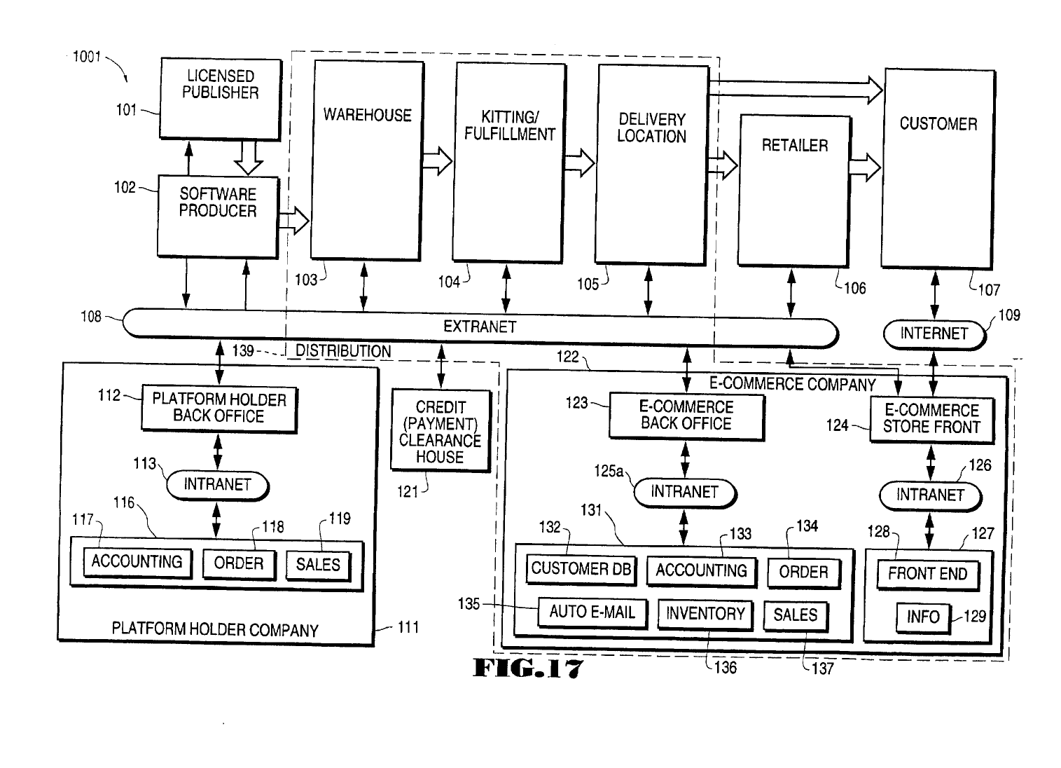

FIG. 17 is a block diagram illustrating a networked distribution system that embodies a flexible format royalty payment method, according to one embodiment of the present invention. In system 1001 of FIG. 17, a licensed software publisher 101 and a software producer 102 produce a software product for sales to a customer 107. Regarding the physical flow of goods, the software product is produced by the software producer 102 on a particular medium, such as CD-ROM, disk, tape, semiconductor storage, or similar type of non-volatile storage medium, and then transported to a warehouse facility 103. When a retail or customer order is received and processed, the product is assembled and kitted in a kitting and fulfillment location 104 and then sent to a delivery site 105. The product is then sent to a retailer 106 where it is ultimately provided or made available to the customer 107.

During the production, storage, delivery, and sales processes described above, data regarding the product and the order are generated by the various parties and processed using various c-commerce based server computers. The data is typically transmitted over one or more computer networks, such as an extranet 108 and/or the Internet 109.

In one embodiment of the present invention, the software product may be a computer game or audio/video product that is published and manufactured for a specific playback system or platform. For example, the product may be a computer game made for the Sony® Playstation™ computer platform. For this embodiment, the system 1001 is linked to a platform holder company 111 that includes a platform holder back office system 112. The platform holder back office system 112 is linked via intranet 113 to a processing system 116 that includes an accounting module 117, an order module 118, and a sales module 119. These modules process and track the orders that pertain to software orders for the particular game or playback platforms managed by the platform holder company 111.

In one embodiment of the present invention, the flexible e-commerce distribution system 1001 includes a point-of-sales e-commerce company 122 that facilitates the payment of royalty and license fees from the software product publishers to the content authors and licensors. The e-commerce company 122 includes an e-commerce back office 123 and an e-commerce storefront 124. These entities are connected through intranet connections 125a and 126 to respective processing systems. The e-commerce back office processing system 131 comprises a customer database 132, an accounting module 133, an order module 134, an inventory module 136, and a sales module 137. Each of these modules perform processing functions related to the inventory, sales and ordering of products from the software producer 102 to the customer 107. Also included in the e-commerce back office processing system 131 is an auto e-mail module 135 that processes the generation and distribution of automatic e-mail correspondence to the various entities within system 1001. The e-commerce store front processing system 127 comprises a front end module 128 that maintains a graphical user interface for the store front, and an information module 129 that populates the store front with relevant data.

In one embodiment of the present invention, an e-commerce distribution system 139 includes the e-commerce company 122, the warehouse facility 103, the kitting site 104, and the delivery site 105. These elements comprise a “virtual” network such that storage, delivery, and processing of an order for a customer is virtually seamless with regard to delivery of products and payment of cost components to the appropriate parties. The distribution system 1001 of FIG. 17 also includes a credit or payment clearance house 121 for the processing of payments involved in the transaction among the platform holder, author, publisher, and customers.

The flexible license payment e-commerce system of the presently preferred embodiment contemplates recording media, such as CD-ROMs, disks, tapes, and the like that include a program executable by a computer, as “articles” to be created, produced and sold to a customer. Since the program has an added value, a person who has the right to develop and sell the program is called a “first added value creator.” It is assumed that the program is executed by a computer operated by the customer. This computer may be a special hardware platform dedicated to play programs affixed to particular media (“format”) and designed for exclusive use with that computer. In this case, since the computer that contains the program itself also adds to the overall value, a person who has the right to manufacture the computer is called a “second added value creator.” Both of these parties may each be referred to generically as an “added value creator,” except for when they need to be distinguished from each other. The articles are consigned for sale to a distributor excluding the first and second added value creators.

In other embodiments, it is important to note that, when the program is sold, the added value creator must pay a consideration (a royalty or license fee) based on intellectual property right relating to the computer, to the developer of the computer. A person who has the intellectual property right relating to the computer and to whom the royalty is paid is called a “format holder.” Also, concerning the articles, distribution is performed by a third party other than the added value creator and the format holder. The third party is hereinafter referred to as the “distributor,” and corresponds to the e-commerce distributor 302 illustrated in FIG. 19. When the distributor purchases articles from the added value creator, a purchase price (“P”) is paid. This purchase price is a price at which the added value creator sells to the distributor. The purchase price (P) includes a manufacturing cost (“a”) of CD-ROMs as articles and a royalty (“c”) that must be paid by the added value creator to the format holder. Accordingly, an amount (P−a−c) obtained by subtracting the manufacturing cost (a) and the royalty (c) from the purchase price (P) is the consideration (“b”) corresponding to the added value, which is to be paid to the added value creator.

The system according to the present invention manages the e-commerce distribution process beginning from the ordering of articles from a manufacturer, throughout the sale of the articles to customers, including instructions for article delivery. The e-commerce distribution server system includes a distribution server (hereinafter “server”) connected by means of a network to the various entities/terminals required for each distribution embodiment of the present invention. One server machine can perform all of the processing in the distribution system server, or the processing can be distributed and performed by a plurality of server machines. The distribution system is not limited to recording media that only contains computer programs. Instead, the system is applicable to media that contains any content, such as recording media like music CDs and DVDs (digital versatile disks) that contain any information having added value, such as music, movies, sound, images, and other information. For the embodiment illustrated in reference to the system of FIG. 17, the e-commerce company 122 could incorporate a server computer that includes an order delivery processor, charging processor, consideration processor, delivery instruction processor, and member management unit, and operates as described in the embodiment discussed with reference to FIG. 13.

In the foregoing, a sales and inventory management system incorporating a flexible license payment method for electronic commerce has been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A computer network system for managing the distribution of an article, the system comprising:
an order accepting process accepting an order for the article from a purchaser; and
a consideration determining process functionally coupled to the order accepting process and determining a value added consideration due to a value added provider of the article, based on information related to the accepted order.

2. The computer network system of claim 1 wherein the value added provider comprises a licensee of the article.

3. The computer network system of claim 2 wherein the added value consideration comprises a licensing royalty to be paid to a creator of the article.

4. The computer network system of claim 3 further comprising a membership management processing system managing a set of members including the purchaser, and wherein the set of members pays the value added consideration in accordance with a predetermined value based on the information related to the accepted order.

5. The computer network system of claim 4 wherein the value added consideration is paid to the value added provider upon the order of a predetermined number of articles by the purchaser.

6. The computer network system of claim 5 wherein the information related to the accepted order comprises an article identifier, a number of articles purchased by the purchaser, and a manufacturing cost for the article.

7. The computer network system of claim 6 further comprising a stock management process associating the manufacturing cost of the article with the value added consideration, and wherein the value added provider bears the manufacturing cost of the article until the order accepting process accepts the order from the purchaser.

8. The computer network system of claim 7 wherein the article comprises a computer readable medium containing one or more programs executable by a computer.

9. A server computer coupled to a network system, the server computer programmed to manage the distribution of an article, and comprising:
an order accepting process accepting an order for the article from a purchaser; and
a consideration determining process functionally coupled to the order accepting process and determining a value added consideration due to a value added provider of the article, based on information related to the accepted order.

10. The server computer of claim 9 wherein the added value consideration comprises a license royalty to be paid to a creator of the article.

11. The server computer of claim 10 further comprising a membership management processing system managing a set of members including the purchaser, and wherein the set of members pays the value added consideration in accordance with a predetermined value based on the information related to the accepted order.

12. The server computer of claim 11 wherein the value added consideration is paid to the value added provider upon the order of a predetermined number of articles by the purchaser.

13. The server computer of claim 12 wherein the information related to the accepted order comprises an article identifier, a number of articles purchased by the purchaser, and a manufacturing cost for the article.

14. The server computer of claim 13 further comprising a stock management process associating the manufacturing cost of the article with the value added consideration, and wherein the value added provider bears the manufacturing cost of the article until the order accepting process accepts the order from the purchaser.

15. The server computer of claim 14 wherein the article comprises a computer readable medium containing one or more programs executable by a computer.

16. A sales management system for articles each having a selling price determined in accordance with at least a manufacturing cost and added value, wherein
the sales management system includes a sales management server and a customer terminal;
said customer terminal has:
an order accepting unit for accepting input order information including at least identification information on an article desired by a purchaser and the number of articles desired by the purchaser; and
an output unit for transmitting the order information to said sales management server; and
said sales management server comprises:
a receiver unit for receiving the order information outputted from said output unit of said customer terminal; and
a consideration determination unit which determines a consideration to be paid to a creator of the added value in accordance with the contents of the order information received by said receiver unit.

17. A sales management system according to claim 16, wherein said sales management server further comprises a consideration transmission unit for transmitting, to a computer of the added value creator, consideration information including at least the consideration to be paid to the added value creator.

18. A sales management system according to claim 17, wherein
said sales management server is linked at least to a computer for controlling delivery of the articles;
the order information further includes delivery-destination designating information designating the destination of an ordered article; and
said sales management server further comprises:
a storage unit for storing customer information including at least one delivery-destination address including a customer's home address; and
a delivery instruction unit which determines a delivery-destination address by referring, based on the delivery-destination designating information, to the customer information, and which transmits, to the computer for controlling delivery, delivery-instruction information including at least identification information on the article desired by the purchaser and the number of articles desired by the purchaser, which are included in the order information, and the delivery-destination address.

19. A sales management system according to claim 18, wherein
said sales management server is linked at least to a computer for controlling delivery of the articles;
the order information further includes delivery-destination designating information designating the destination of an ordered article; and
said sales management server further comprises:
a storage unit for storing customer information including at least one delivery-destination address including a customer's home address; and
a delivery instruction unit which determines a delivery-destination address by referring, based on the delivery-destination designating information, to the customer information, and which transmits, to the computer for controlling delivery, delivery-instruction information including at least identification information on the article desired by the purchaser and the number of articles desired by the purchaser, which are included in the order information, and the delivery-destination address.

20. A sales management server for articles each having a selling price determined in accordance with at least a manufacturing cost and added value, said sales management server comprising:
a receiver unit for receiving order information including at least article-identification information and the number of articles to be purchased;
a consideration determination unit which determines a consideration to be paid to a creator of the added value in accordance with the contents of the order information after said receiver unit receives the order information; and
a consideration transmission unit for transmitting, to a computer at a site of the added value creator, consideration information including at least the consideration to be paid to the added value creator.

21. A sales management server according to claim 20, wherein
said articles are recording media on each of which a computer-readable program is fixed; and
the added value creator is a person having the right to sell the program.

22. A method for selling, by an agent, articles each having a selling price determined in accordance with at least a manufacturing cost and added value, said method comprising the steps of:
purchasing said articles at said manufacturing price, storing the purchase price, and keeping said articles in stock; and
paying, after selling each of the articles in stock, a consideration corresponding to the added value, to a creator of the added value.

23. A computer-readable recording medium containing a program to be executed by a computer as a server managing the sale of articles each having a selling price determined in accordance with at least a manufacturing cost and added value, said computer-readable recording medium, wherein said program comprises the steps of:
receiving order information including at least article-identification information and the number of articles to be purchased;
determining, after receiving said order information, a consideration to be paid to a creator of the added value in accordance with the contents of the order information; and
transmitting, to a computer at a site of the added value creator, consideration information including at least the consideration to be paid to a creator of the added value.

24. A program to be executed by a server for managing the sale of articles each having a selling price determined in accordance with at least a manufacturing cost and added value, wherein said program allows a computer as said server to execute the steps of:
receiving order information including at least article-identification information and the number of articles to be purchased;
determining, after receiving said order information, a consideration to be paid to a creator of the added value in accordance with the contents of the order information; and
transmitting, to a computer at a site of the added value creator, consideration information including at least the consideration to be paid to the added value creator.

25. A sales management system for articles each having a selling price determined in accordance with at least an article manufacturing cost and the added value thereof, said sales management system comprising:
a receiver unit for receiving an article manufacturing cost and the number of articles manufactured which are inputted;
a storage unit for storing the inputted manufacturing cost and number of articles manufactured;
an order-accepting unit for accepting an order by receiving at least identification information of an ordered article and the number of articles;
a stock-article calculation unit for calculating the number of articles in stock at a specific time from the number of the manufactured articles stored in said storage unit and the number of ordered articles received by said order-accepting unit; and
a stock balance calculation unit for calculating a balance of stock at the specific time based on the calculated number of articles in stock and the manufacturing cost stored in said storage unit,
wherein the balance of stock calculated by said stock balance calculation unit does not include at least a consideration corresponding to the added value.

26. A sales management system according to claim 25, further comprising:
a consideration-calculation unit which calculates the amount of a consideration in accordance with the number of the ordered articles from information on the consideration corresponding to the added value and the number of the ordered articles received by said order-accepting unit; and
an output unit which transmits, to a computer of the added value creator, information which includes the amount of the consideration calculated by said consideration-calculation unit.

27. A sales management system according to claim 26, further comprising:
a unit for calculating, based on the purchase cost of said articles, the amount of a consideration to be paid by the added value creator;
an output unit for transmitting, to a computer of a person receiving the consideration, information including the calculated amount of the consideration to be paid by the added value creator;
a unit for calculating the amount to be paid to the added value creator from the calculated amount of the consideration to be paid by the added value creator, the manufacturing cost stored in said storage unit, and the purchase cost; and
an output unit for transmitting, to a computer of the added value creator, information including the calculated amount of the consideration to be paid to the added value creator.

28. A sales management system according to claim 27, further comprising:
a unit for calculating the amount of a consideration corresponding to added value per article from at least the purchase price of said articles, and the manufacturing cost stored in said storage unit;
a unit for calculating the amount of a consideration in accordance with the number of ordered articles from the amount of the consideration per article, calculated by said calculating unit, and the number of ordered articles received by said order-accepting unit; and
an output unit for transmitting the amount of the consideration, calculated by said consideration-amount calculating unit, in accordance with the number of ordered articles to a computer of the added value creator.

29. A sales management system for articles each having a selling price determined in accordance with at least an article manufacturing cost and an added value thereof, said sales management system having a first and a second servers wherein said first and second servers are connected to each other via a network, wherein
said first server has:
an order accepting unit for accepting an order by receiving at least an article identification information and the number of ordered articles from an outside source;
an order placing unit for outputting order information to a computer for an added value creator of the ordered articles after said order accepting unit accepts the order; and
a shipping processing unit for transmitting, to a computer of a distributor and the second server, shipping information so as to instruct the distributor to ship the ordered articles after the ordered articles in accordance with the order information outputted by the order accepting unit, are received; and
said second server has:
a receiver unit for receiving said shipping information transmitted from said first server;
a sales processing unit for processing sales of said articles in accordance with the shipping information received by said receiver unit;
a consideration determination unit which determines, in accordance with the shipping information received by said receiver unit, the amount of consideration, corresponding to the added value, which is to be paid to said added value creator; and
a transmitter unit for transmitting, to the computer of said added value creator via the network information on the consideration, corresponding to the added value, determined by said consideration determination unit, and the number of ordered articles accepted by said order accepting unit.

30. A sales management system according to claim 29, further comprising an output unit for transmitting, to the computer of said added value creator, information including the consideration determined by said consideration determination unit.

31. A sales management system according to claim 30, further comprising an output unit for transmitting, to the computer of said added value creator, information including the consideration determined by said consideration determination unit.

32. A sales management system according to claim 31, further comprising:
a storage unit for storing an article identification information and information on purchase price of said article by associating with each other;
a unit for determining the amount of a consideration to be paid by the added value creator, based on information on the purchase price acquired from said storage unit by means of corresponding to said article identification information accepted by said order accepting unit; and
an output unit for transmitting, to a computer of said added value creator, information including the consideration amount corresponding to said added value and the consideration amount determined by said unit for determining the amount of a consideration to be paid by the added value creator.

33. A sales management system according to claim 32, further comprising:
a storage unit for storing an article identification information and information on purchase price of said article by associating with each other;
a unit for determining the amount of a consideration to be paid by the added value creator, based on information on the purchase price acquired from said storage unit by means of corresponding to said article identification information accepted by said order accepting unit; and
an output unit for transmitting, to a computer of said added value creator, information including the consideration amount corresponding to said added value and the consideration amount determined by said unit for determining the amount of a consideration to be paid by the added value creator.

34. A computer-implemented method for managing the sale of an article from a product distributor, the method comprising:
receiving payment corresponding to a selling price for the article, the payment being received by a distributor of the article from a buyer of the article;
determining a royalty due to a licensor of the article, based on the selling price of the article;
transmitting, from the distributor to a manufacturer of the article, portions of the selling price payment corresponding to a royalty and a licensee margin portion of the selling price, wherein the manufacturer is a licensee of the article; and
transmitting, from the licensee to the licensor, payment corresponding to the royalty, upon a sale the article to the customer.

35. The method of claim 34 wherein the article is a computer program affixed to a computer readable medium, and wherein the royalty is a format royalty.

36. The method of claim 35 wherein the licensee is a publisher of the computer program and the licensor is an author of the computer program.

37. The method of claim 36 wherein the licensee is a publisher of the computer program and the licensor is a format holder associated with the medium upon which the computer program is affixed.

38. The method of claim 36 wherein the royalty portion is determined in relation to the cost price, the cost price comprising a manufacturing cost of the article, the format royalty, and the licensee margin.

39. The method of claim 38 further comprising the steps of:
receiving an article manufacturing cost and a manufactured article quantity, wherein the selling price is determined in relation to the manufacturing cost and an added value including the format royalty;
accepting an order by the customer by receiving ordered article identification information and the manufactured article quantity;
determining a stocked article quantity in relation to the manufactured article quantity and an ordered article quantity; and
determining a balance of stock in relation to the determined stocked article quantity and the manufacturing cost, wherein the balance of stock is not determined in relation to a consideration corresponding to the added value.

40. A server computer coupled to a network, and configured to manage the sale of an article from a product distributor, the server computer comprising:
means for receiving payment corresponding to a selling price for the article, the payment being received by a distributor of the article from a buyer of the article;
means for determining a royalty due to a licensor of the article, based on the selling price of the article;
means for transmitting, from the distributor to a manufacturer of the article, a portion of the selling price payment corresponding to a licensee margin portion of the selling price, wherein the manufacturer is a licensee of the article; and
means for transmitting, from the distributor to the licensor, a portion of the selling price payment corresponding to the royalty upon a sale the article to the customer.

41. The server computer of claim 7 wherein the article is a computer program affixed to a computer readable medium, and wherein the royalty is a format royalty.

42. The server computer of claim 41 wherein the licensee is a publisher of the computer program and the licensor is an author of the computer program.

43. The server computer of claim 41 wherein the licensee is a publisher of the computer program and the licensor is a format holder associated with the medium upon which the computer program is affixed.

44. The server computer of claim 43 wherein the royalty portion is determined in relation to the cost price, the cost price comprising a manufacturing cost of the article the format royalty, and the licensee margin.

45. The server computer of claim 44 further comprising:
means for receiving an article manufacturing cost and a manufactured article quantity, wherein the selling price is determined in relation to the manufacturing cost and an added value including the format royalty;
means for accepting an order by the customer by receiving ordered article identification information and the manufactured article quantity;
means for determining a stocked article quantity in relation to the manufactured article quantity and an ordered article quantity; and
means for determining a balance of stock in relation to the determined stocked article quantity and the manufacturing cost, wherein the balance of stock is not determined in relation to a consideration corresponding to the added value.

46. A system for managing the distribution of an article from a distributor to one or more customers, the system comprising:
a licensor who is authorized to make and sell the article and grant production and sales rights to third party entities in exchange for a royalty;
a distributor including one or more locations adapted to warehouse and deliver the articles, and an electronic commerce server configured to store information regarding the identity of the article, a cost price associated with the article, and a selling price associated with the article;
a licensee who is authorized by the licensor to manufacturer the product in exchange for the royalty, wherein the licensee, licensor, and distributor are connected by a computer network and wherein royalty payments are made to the licensee upon sale of the article by the distributor to a customer.

47. The system of claim 46 wherein the royalty is determined in relation to the article selling price, the selling price comprising a manufacturing cost of the article, one or more value added cost components, and a distributor cost margin.

48. The system of claim 47 wherein the royalty is determined in relation to the article cost price, the cost price comprising a manufacturing cost for the article and one or more value added cost components.

49. The system of claim 48 wherein the distributor pays a portion of the selling price corresponding to the royalty and licensee margin to the licensee, and the licensee pays a portion of the selling price corresponding to the royalty to the licensor.

50. The system of claim 49 wherein the distributor pays a portion of the selling price corresponding to the royalty to the licensor and the distributor pays a portion of the selling price corresponding to the licensee margin to the licensee.

51. The system of claim 50 wherein the article is a computer program affixed to a computer readable medium, and wherein the royalty is a format royalty, and wherein the licensee is a publisher of the computer program and the licensor is an author of the computer program.

52. The system of claim 51 wherein the licensee is a publisher of the computer program and the licensor is a format holder associated with the medium upon which the computer program is affixed.
